(19) United States
(12) Patent Application Publication
(10) Pub. No.: US 2016/0274572 A1
(43) Pub. Date: Sep. 22, 2016

(54) Three Dimensional (3D) Printing and CAD File Quoting System

(71) Applicants: Michael G. Littrell, Crystal Lake, IL (US); Frederick Knecht, Woodstock, IL (US)

(72) Inventors: Michael G. Littrell, Crystal Lake, IL (US); Frederick Knecht, Woodstock, IL (US)

(21) Appl. No.: 15/074,772

(22) Filed: Mar. 18, 2016

Related U.S. Application Data
(60) Provisional application No. 62/135,681, filed on Mar. 19, 2015.

(51) Int. Cl. G05B 19/4099

(52) U.S. Cl. CPC G05B 19/4099; G05B 2219/49023; G05B 2219/23005

(57) ABSTRACT

A system and method for a three dimensional (3D) printing quoting tool and system is provided for in the present invention. The 3D printing tools contemplated are capable of taking information from and presenting information to customers in order for the customer to have selective input into various aspects of such design and fabrication which affect price of a customized 3D part, and the printer to accurately price a customized 3D part.

### BACKGROUND OF THE INVENTION

1. Field of the Invention

The present invention generally relates to an improved three dimensional (3D) printing quoting tool and system. More particularly, the present invention relates a viewing and quoting tool that may be used internally over a local area network (LAN), over the internet, or by other similar means. The 3D printing tools contemplated are capable of taking information from and presenting information to customers in order for the customer to have selective input into various aspects of such design and fabrication which affect price of a customized 3D part, and the printer to accurately price a customized 3D part.

2. Discussion of the Prior Art

U.S. Pat. No. 6,836,699 provides a automated, custom mold manufacture for a part begins by creating and storing a collection of information of standard tool geometries and surface profiles machinable by each of the standard tool geometries. A customer sends a CAD file for the part to be molded to the system. The system assesses the CAD file to determine various pieces of mold manufacturing information. One or more acceptability criteria are applied to the part, such as whether the part can be manufactured in a two-piece, straight-pull mold, and whether the mold can by CNC machined out of aluminum. If not, the system sends a file to the customer graphically indicating which portions of the part need modification to be manufacturable. The system provides the customer with a quotation form, that allows the customer to select several parameters, such as number of cavities, surface finish and material, which an independent of the shape of the part. The quotation module then provides the customer with the cost to manufacture the mold or a number of parts. The quotation is based in part upon mold manufacturing time as automatically assessed from the part drawings and based in part on the independent parameters selected by the customer. The customer's part is geometrically assessed so the system automatically selects appropriate tools and computes tool paths for mold manufacture. In addition to the part cavity, the system preferably assesses the parting line, the shutoff surfaces, the ejection pins and the runners and gates for the mold. The preferred system then generates CNC machining instructions to manufacture the mold, and the mold is manufactured in accordance with these instructions.

U.S. Pat. No. 7,120,510 provides method of executing a plurality of steps that are performed sequentially in temporal order under computer control. Each of the plurality of steps is executed by one of a plurality of terminal computers. When a terminal computer assigned to a step has completed the work in the step and is able to execute the work in the next step, it sends a work completion signal to a central processing computer. The central processing computer receives this work completion signal and prepares a work item notice that indicates that the next step can be started, such that the notice can be displayed on the screen of the terminal computer used for the next step. The terminal computer used for the next step allows the notice displayed on its screen to be clicked to start work on the next step assigned to it.

U.S. Pat. No. 7,590,466 Disclosed an automated, custom mold manufacture for a part begins by creating and storing a collection of information of standard tool geometries and surface profiles machinable by each of the standard tool geometries. A customer sends a CAD file for the part to be molded to the system. The system assesses the CAD file to determine various pieces of mold manufacturing information. One or more acceptability criteria are applied to the part, such as whether the part can be manufactured in a two-piece, straight-pull mold, and whether the mold can by CNC machined out of aluminum. If not, the system sends a file to the customer graphically indicating which portions of the part need modification to be manufacturability. The system provides the customer with a quotation form, that allows the customer to select several parameters, such as number of cavities, surface finish and material, which an independent of the shape of the part.

U.S. Pat. No. 8,014,889 is a method (10) for manufacturing a three-dimensional object. The method (10) includes receiving (14) digital information of the three-dimensional object over a communication line and building (30) the three-dimensional object based at least in part on the received digital information, where at least part of the three-dimensional object is built by rapid manufacturing, and where the three-dimensional object comprises an exterior surface. The method also includes vapor smoothing (32) at least a portion of the exterior surface of the three-dimensional object.

United States Patent Publication No. 20030126038 discloses an automated, custom mold manufacture for a part begins by creating and storing a collection of information of standard tool geometries and surface profiles machinable by each of the standard tool geometries. A customer sends a CAD file for the part to be molded to the system. The system assesses the CAD file to determine various pieces of mold manufacturing information. One or more acceptability criteria are applied to the part, such as whether the part can be manufactured in a two-piece, straight-pull mold, and whether the mold can by CNC machined out of aluminum. If not, the system sends a file to the customer graphically indicating which portions of the part need modification to be manufacturable. The system provides the customer with a quotation form, that allows the customer to select several parameters, such as number of cavities, surface finish and material, which an independent of the shape of the part. The quotation module then provides the customer with the cost to manufacture the mold or a number of parts. The quotation is based in part upon mold manufacturing time as automatically assessed from the part drawings and based in part on the independent parameters selected by the customer. The customer's part is geometrically assessed so the system automatically selects appropriate tools and computes tool paths for mold manufacture. In addition to the part cavity, the system preferably assesses the parting line, the shutoff surfaces, the ejection pins and the runners and gates for the mold. The preferred system then generates CNC machining instructions to manufacture the mold, and the mold is manufactured in accordance with these instructions.

### SUMMARY OF THE INVENTION

A difficulty with presently available 3D Printing and Quoting Systems is that they often result in wildly inaccurate quotations for customers and potential customers. Current systems often merely approximate the amount of material to be used in printing and forming the 3D object and create a quotation based on the volume or mass of the object imported into the system. This method of quoting often results in manufacturers creating certain parts far below cost, cutting deeply into profitability. Or, in certain applications, creates a waste of materials and time on a 3D printing device (particularly important to certain companies/universities with internal 3D printing machines or departments). Oftentimes this is solved by manufacturers manually pricing a job, or by simply overpricing parts to avoid losses on any individual part. However those methods are generally inefficient, nor do they solve the underlying problem of having a non-optimized electronic quoting system. Thus, a the quoting systems and tools of the present invention are capable of accurately calculating the materials used, waste, time to completion, and other variable costs associated with 3D printing a particular physical object.

Such an application is capable of being used with several types of computer aided drafting (CAD) or representative 3D models that are imported into the system as files. In addition, the graphical user interface (GUI) of the system allows a user or consumer to view, rotate, and manipulate the file in 3D space allowing for rotation about the X, Y, and Z axes. This allows the user to verify their design was properly uploaded and scale the part to desired dimensions.

Typical 3D printers utilize one of four major types of 3D printing technology: Stereolithography (SLA), Selective Layer Sintering (SLS), Fused Deposition Modeling (FDM), PolyJet/InkJet 3D Printing and the system of the present invention is capable of modeling a printing tray for any of those process, as well as is capable of modeling newer and unique methods of 3D manufacture with only simple adjustments by the administrator or manufacturer.

Two issues that drive errors in typical 3D printing price quoting software are: 1) The amount of support structure used in printing; and 2) The time to completion for a print job. In 3D printing, portions of the part that are not vertically positioned over another part must be supported by a “support structure”, the material used in support structure is similar to that which is used in creating the actual part, but often requires a separate “printing head” to create the support structure as opposed to the actual portions of the printed object. Thus, if the amount of support structure is not accurately modeled the amount of material (support structure) used may be vastly over, or underestimated, as will the number of times the 3D printer will have to change printing heads, which can greatly increase time to completion.

Thus, the current system has several unique features that result in a more accurate pricing system, and even the ability to optimize the printing process. Firstly, the system can generate and define a buildable area that represents the 3D printing device to be used in the final process and can place a part in that area. The buildable area will have a support surface (build tray, floor) to which the software can snap the digital part to, “grounding” the part. The system also calculates the “envelope” for the desired part, the 3D box that contains the dimensions of the part along an X, Y, and Z axis, to ensure it can be constructed within the buildable area. This then allows the system to calculate the amount of support material needed (and display that to the user) and allow the user to re-orient the part inside the buildable area and visualize the support alongside the part. It can also simultaneously calculate the estimated time to completion for 3D printing the part. Then the system can calculate a price per piece based on the quantity desired by the customer/user and submit orders (if desired) to the manufacturer. Thus, this process is uniquely capable of pre-calculating time and wasted materials in ways that previous pricing tools cannot.

To achieve these objectives, a 3D Printing and CAD File Quoting System, methods, and tools having the following features is proposed.

A method for generating a quote for a three dimensional (3D) printed object, the method having at least the steps of: providing a user generated 3D model, importing said user generated 3D model into a 3D printing quote generation system, analyzing the user generated 3D model and generating a 3D envelope around said model, the 3D envelope corresponding to the X, Y, and Z dimensions of the user generated 3D model, instantiating a buildable area and a support surface in the quote generation system, displaying the user generated 3D model, buildable area, and support surface in a graphical user interface (GUI), orienting the user generated 3D model within the buildable area, snapping the user generated 3D model to the support surface and displaying such in the GUI, generating a digital support structure for the user generated 3D model based on the orientation of the user generated 3D model, and generating a quote for a three dimensional (3D) printed object based on the user generated 3D model.

In certain embodiments the user can manually reorient the user generated 3D model within the buildable area about the user generated 3D model's X, Y, or Z axis. In a preferred embodiment the quote generation system provides the user options for optimizing the orientation of the user generated 3D model to minimize support structure or price, and calculating the optimal orientation for the user's selected choice and displaying said orientation to the user in the GUI. Other features are contemplates such as: the user can selectively hide the support structure in the GUI, the manufacturer can customize a set of variables affecting the quote, scaling the user generated 3D model within the quote generation system, detecting defects in the user generated 3D model that would prevent proper manufacture of the three dimensional (3D) printed object, notifying the user of said defects, interrupting generation of the quote when said defects would prevent manufacture of the three dimensional (3D) printed object, sometimes the user is prompted to contact an administrator when generation of the quote is interrupted, a list of defects detectable may preferably be defects detected in the user generated 3D model are selected from the group comprising: thin walls; non-manufacturable holes; and non-manufactuable dimensions. Preferably there is a feature allowing for manufacturing the three dimensional (3D) printed object.

In a second embodiment the invention contemplates a method of manufacturing a three-dimensional (3D) object, the method comprising: providing a digital manufacturing system, the manufacturing system providing a graphical user interface (GUI) to a customer, receiving digital information from the customer wherein the digital information comprises: a digital representation of the 3D object, displaying the digital representation in the GUI, generating a digital support structure for the digital representation corresponding to a support structure for the 3D object, calculating a quotation for 3D printing the 3D object based upon a set of cost-affecting parameters determined by computer assessment of at least the 3D object and support structure, communicating the quotation to the customer, and upon acceptance of the computer calculated quotation by the customer, 3D printing the three dimensional object.

Preferably the method of manufacture may also include: generating a 3D envelope around the digital representation, the 3D envelope corresponding to the X, Y, and Z dimensions of the user generated 3D model, instantiating a buildable area and a support surface in the quote generation system; and displaying the buildable area, support surface, and 3D envelope in the GUI. Additionally the 3D envelope is automatically oriented in the buildable area such that it connects to the support surface, the digital support structure connects portions of the 3D object to the support surface. In other cases the customer can reorient the digital representation in the buildable area around the X, Y, or Z axis of the digital representation, and the digital manufacturing system automatically recalculating the amount of support structure required for a new orientation and displaying said new support structure in the GUI. The user can selectively hide the support structure in the GUI.

In a third embodiment the invention contemplates a method for generating a price quote for at least one three dimensional (3D) printed object comprising: receiving a customer's computer aided drafting (CAD) file corresponding to at least one 3D printable object, providing the customer with at least one computer menu of customer-selectable options for manufacturing the at least one 3D printable object, and allowing the customer to select one of the provided customer-selectable options assessing the customer's CAD file via computer to determine the volume of material in the at least one 3D printable object, the amount of support structure required to print the at least one 3D printable object; and the time required to print the at least one 3D printable object, computer calculating a price quote for 3D printing the at least one 3D printable object based on at least the material in the at least one 3D printable object, the amount of support structure required to print the at least one 3D printable object; and the time required to print the at least one 3D printable object, thereby generating a price quote, and communicating the quote to the customer via computer.

Preferably the method can also allow for computer calculating the price quote further comprises accounting for variables selected from the list comprising: the number of changes in printing heads, the amount of material wasted, and time thresholds. The method also includes generating a buildable area comprising an open area and a build tray, orienting the CAD file within the buildable area such that it is located on the build tray, and generating the support structure required to print the at least one 3D printable object corresponding the CAD file as oriented in the buildable area. The user can manually re-orient the CAD file along the X, Y, or Z axis of the CAD file, and then the computer recalculates the price quote based on the orientation of the CAD file. Preferably, the amount of support structure estimated has less than a five percent error when compared to the amount of support structure actually required to print the at least one 3D printable object.

Such embodiments do not represent the full scope of the invention. Reference is made therefore to the claims herein for interpreting the full scope of the invention. Other objects of the present invention, as well as particular features, elements, and advantages thereof, will be elucidated or become apparent from, the following description and the accompanying drawing figures.

### BRIEF DESCRIPTION OF THE DRAWINGS

Other features of my invention will become more evident from a consideration of the following brief descriptions of drawings:

FIG. 1 is a perspective view of a representative 3D Part shown within the price quoting system according to the present invention.

FIG. 2 is a perspective view of a representative 3D Part shown within the price quoting system with additional support structure shown according to the present invention.

FIG. 3 is a perspective view of the representative 3D Part of FIG. 1 reoriented within the price quoting system of the present invention.

FIG. 4 is a perspective view of the representative 3D Part reoriented as in FIG. 3 with rebuilt additional support structure.

FIG. 5 is a perspective view of a representative 3D Part shown within the price quoting system with functional options demonstrated.

FIG. 6 shows exemplary transactions for pricing a 3D printing job using the system of the present invention.

FIG. 7 is a representative quote as output by the current invention.

### DETAILED DESCRIPTION OF THE PREFERRED EMBODIMENT

Referring now the drawings with more specificity, the present invention essentially provides a Three Dimensional (3D) Printing and CAD File Quoting System, or a viewer and quote engine for 3D parts corresponding to the 3D printing of those parts. Using the present invention a user may import a file from his computer into the 3D quoting system and receive a price quote from the system based on the size, scope, orientation, and other relevant factors related to the part. In addition the system can be programmed with several other variables and features discussed below.

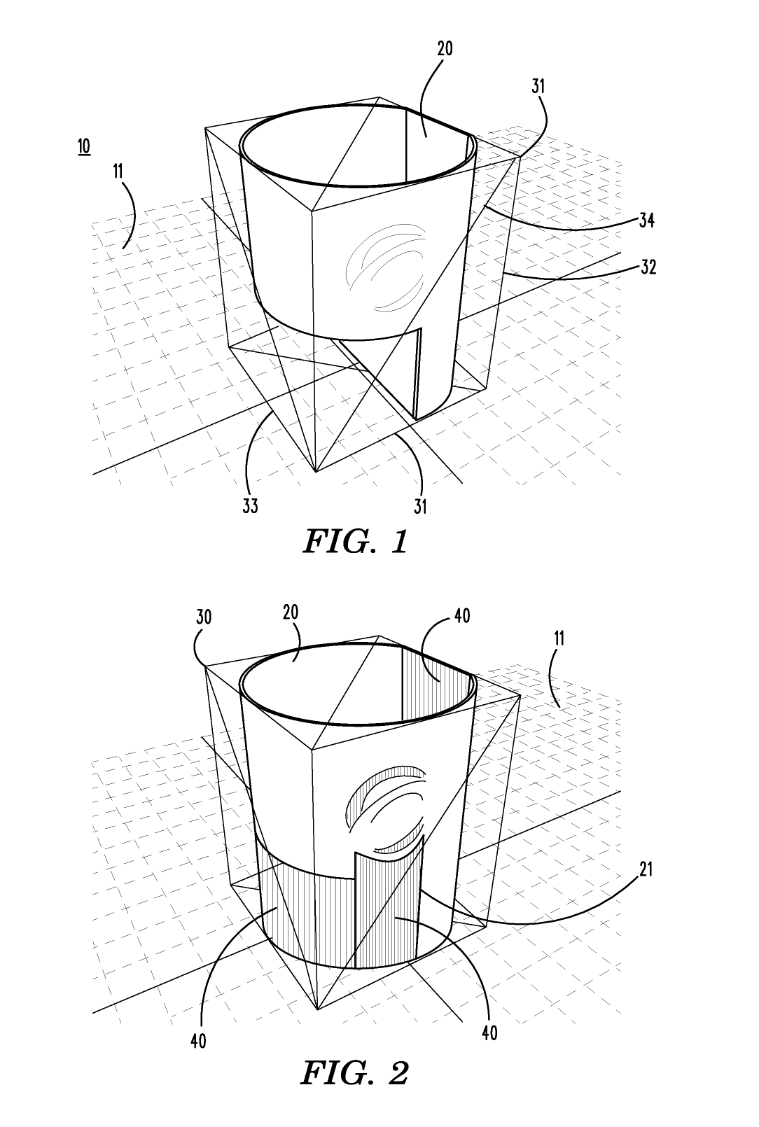

Looking now to FIG. 1 a representative 3D Part 20 is show in the 3D quoting system's Graphical User Interface (GUI) 10. Part 20 will typically represent a user's stereolithography (STL) format file, but other file formats are contemplated for use with the 3D quoting system through conversion and direct implementation. The GUI will typically involve drop down menus, radio buttons, and other conventional features that allow the user to select the process for making the part, color, density, finish, and other factors. In addition to conventional features of a 3D price quoting system the system of the present invention includes a representative printing tray or support surface 11. The printing tray 11 can be scaled to represent the tray or surface of the 3D printing machine corresponding to the printing process the user selects (such as FDM, SLS, SLA, or other printing processes). Also unique to the present invention is the system's construction of an envelope or boxed border 30 around 3D Part 20.

Envelope 30 shows a graphical representation of the X (31), Y (33), and Z (32) dimensions of the part as it is currently orientated. This envelope shows to the user the footprint of the part 20 within the build space 10, and particularly the footprint on printing tray 11. In certain configurations additional parts will be able to be manufactured simultaneously depending on the part's footprint, thereby affecting the price quote. In certain situations diagonals 34 are also shown in the envelope and may confer to the user additional information.

As can be seen in FIGS. 1 & 2 and additionally in other orientations in FIGS. 3 & 4 the price quotation system consistently can orient the part such that it is touching or adjacent to the printing tray 11. This is a necessary step for generating support structure 40 which connects portions of piece 20 to tray 11 and supports them during the printing process. Support material is essential to the majority of modern 3D printing processes. A part (such as part 20) is printed one layer at a time, and without support material essential portions of the 3D printed part will fall to the base tray, into the undercuts, or through hollow features as the part is being printed. Thus, support material, or support structures 40 are used to hold layers in place and keep the base material out of the way.

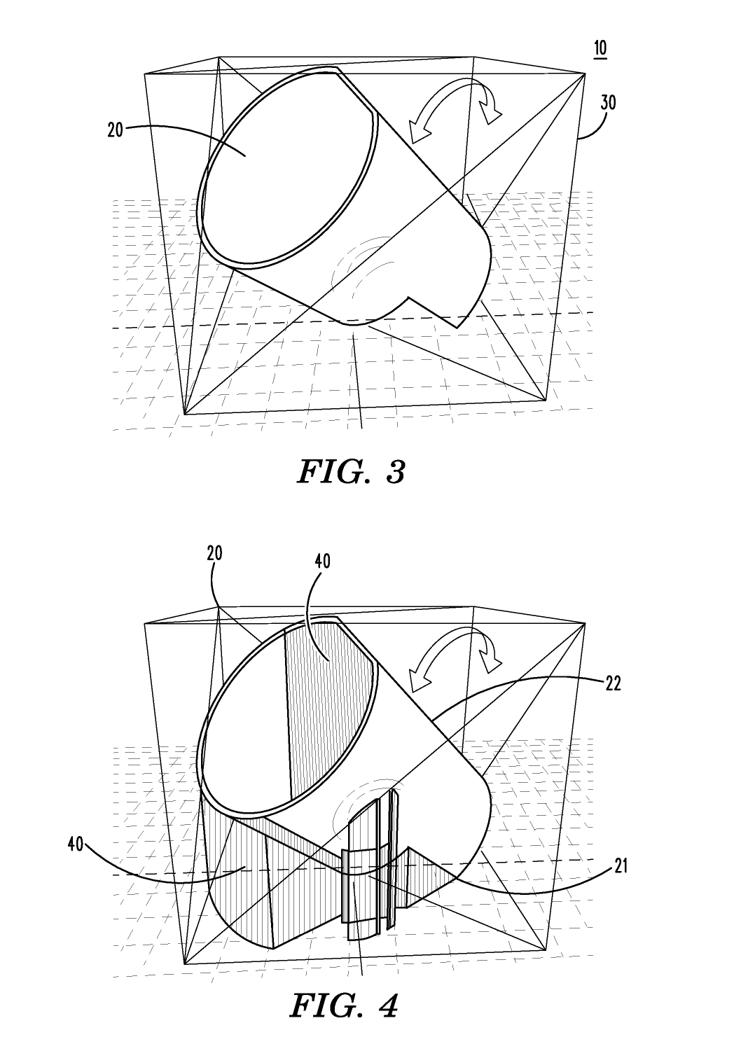

Typical 3D printing quoting systems have no way of accurately modeling support material 40. Mistakes in estimating the amount of support material used in printing often exceed 50% of the cost of printing the part. Thus, support structure (along with part size, time to print, and other factors) is a major factor in driving costs for the manufacturer and failures in estimation can cause major cost overruns. Thus as can be seen in FIGS. 2 & 4 the system of the current invention can generate and pre-render the support structure dynamically as the part is oriented within the space 10. And as can be seen different support structures can be constructed for the same part depending on the orientation and reorientation of the part. The current system can estimate the total amount of support structure used with less than 10% error and typically in most cases the error is less than 5%.

One additional cost driver of present 3D printing processes is that printers typically must switch between separate printing heads when printing support material 40 and the part 20. This is essential as the support material is constructed from a different composition for simple removal later (some implementations utilize chemical baths to dissolve support structure). Changing and cleaning printer heads takes time and thus increases the cost of manufacturing a part. For example, printing at boundary 21 (seen in FIGS. 2 & 4) requires a change from printing support structure 40 to part 20 necessitating a change in printer heads. Thus, one additional benefit of the current system is that by accurately rendering support structure 40, the system can also accurately calculate the number of times the printer heads will have to trade off, and estimate the time and cost associated with those changes, greatly increasing the accuracy of the final price quote.

As can be seen with greater specificity in FIGS. 3 & 4, one critical aspect of the current invention is the ability of the user to re-orient the 3D part 20 within the interface 10 and the system's ability to automatically reconfigure and recalculate the support structure 40. The user can choose to reorient the part 20 around any of its X, Y, or Z axes thus giving the user total control over the printing process. While the system may also have an “auto orient” feature that will minimize the cost for the consumer, certain parts will have intricate features that a user may not want to be exposed to support structure. By way of example, a user may desire the orientation of FIGS. 3 & 4 as side 22 of the part 20 is not supported by support structure on the exterior. If there are details, such as a logo, being 3D printed on that side of the part, this orientation would preserve the integrity of those fine features.

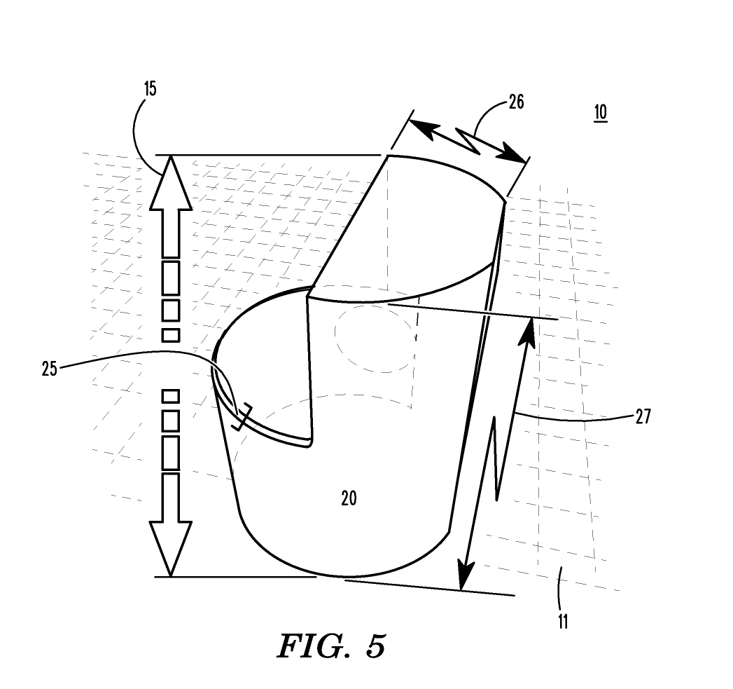

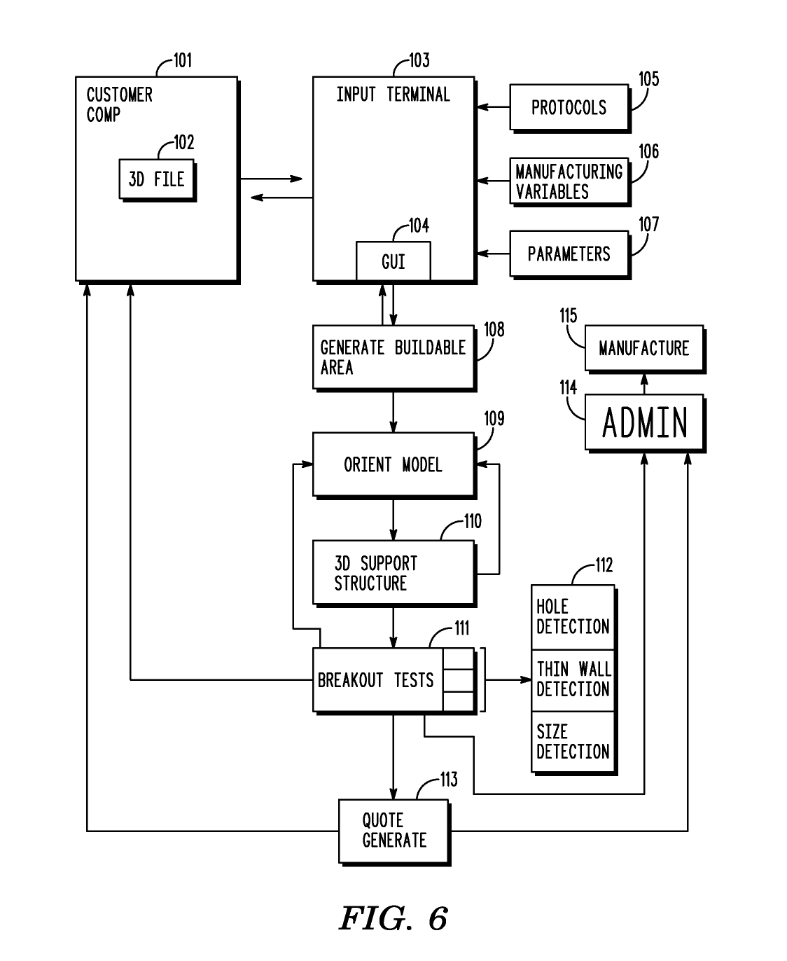

Additional, optional, features of the invention are shown in FIG. 5. One feature of preferred embodiments of the price quoting system is the ability to scale the model of within the system. Users can dynamically scale the model 20, either by using the dimensions selecting tool (in, cm, mm, etc) or by selecting a percentage (%) of the current dimensions of the object as shown by arrows 15. Certain dimensions of the part 20 such as edge 25, width 26, and height 27 can be dynamically extracted by the system and displayed to the user. Additionally, at certain stages the system will warn users that certain aspects of the model are not printable with the 3D printing process they have selected. Often this is due to excessive dimensions, thin walls, or unprintably small holes (as seen in FIG. 6).

Looking now with greater specificity to FIG. 6 exemplary actions, methods, and transactions for price quoting and order placement are show. In a typical transaction, as shown in FIG. 6, the customer loads a file 102 on his computer 101, preferably this is a STL file, but other files are often used. The user than sends the file 102 to the manufacturer's input terminal or processing system 103. The system is equipped with a GUI 104. The terminal 103 is pre-loaded with protocols 105, manufacturing variables 106, and design parameters 107, such pre-loaded features are discussed in greater detail throughout the specification but may include material costs, manufacturing times, factory layout, etc.

The input terminal 103 then generates a buildable area 108 based on the design parameters and user preferences and displays them to the user in the GUI. The 3D file 102 is then displayed in the GUI and oriented 109 within the GUI and buildable area. The user may also selectively reorient 109 the model 102 according to his own preferences. The system then generates a 3D support structure 110 for the 3D file according to the orientation and size of the part and displays the support material and model to the user. In certain cases the user may then re-orient the model and the system will dynamically regenerate the 3D support structure 110 according to the new orientation of the part. The system also will conduct a series of tests 111, such as hole detection, thin wall detection, and size detection 112 which may notify the user's computer 101 of possible manufacturing issues for the part as currently oriented and generated. The customer can then choose to re-orient and modify the part to fit within typical design parameters or submit the part to an administrator 114 for a manual price quote. If no errors are detected the system can automatically generate a price quote 113 for the customer 101 who can then submitted to the Administrator 114 for final approval and manufacture 115.

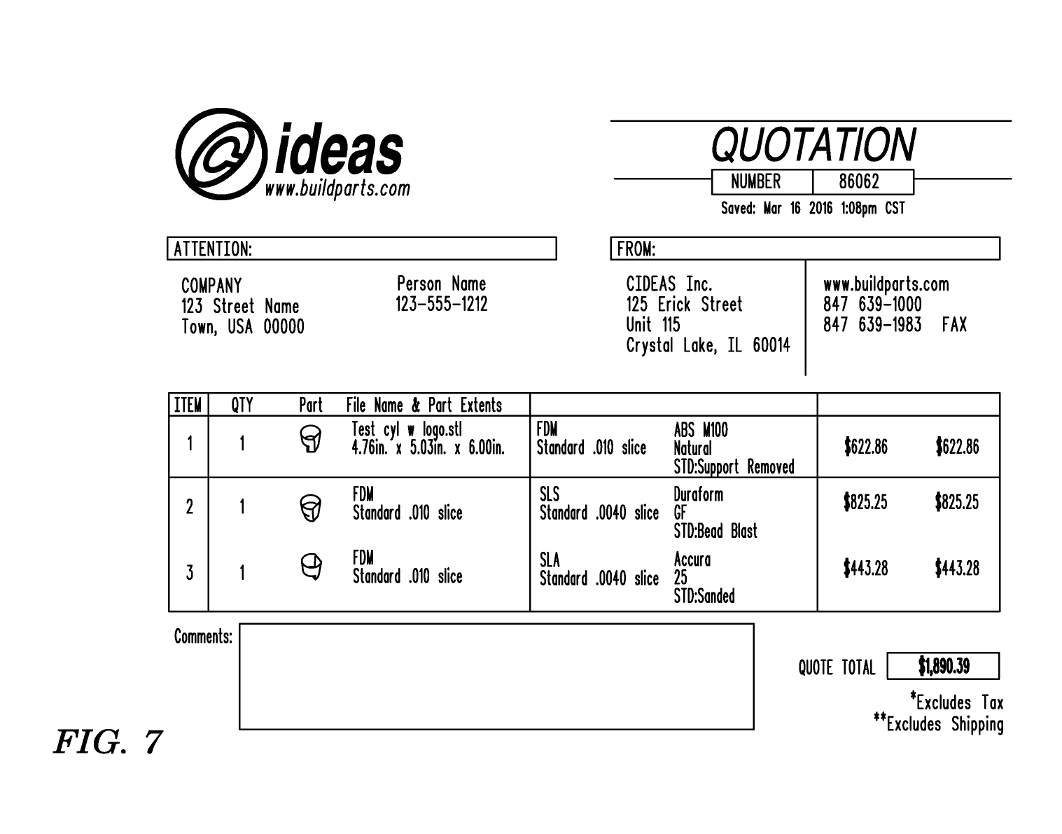

An exemplary price quote output page is shown in FIG. 7. Shown outputs include (but are not limited to) parts, quantity, file name and type, manufacturing process and manufacturing specifications, finish, unit price, total price, and other variables relevant to the consumer.

Accordingly, although the invention has been described by reference to certain preferred and alternative embodiments, it is not intended that the novel arrangements be limited thereby, but that modifications thereof are intended to be included as falling within the broad scope and spirit of the foregoing disclosures and the appended drawings.

We claim:

1. A method for generating a quote for a three dimensional (3D) printed object comprising:
providing a user generated 3D model;
importing said user generated 3D model into a 3D printing quote generation system;
analyzing the user generated 3D model and generating a 3D envelope around said model, the 3D envelope corresponding to the X, Y, and Z dimensions of the user generated 3D model;
instantiating a buildable area and a support surface in the quote generation system;
displaying the user generated 3D model, buildable area, and support surface in a graphical user interface (GUI);
orienting the user generated 3D model within the buildable area;
snapping the user generated 3D model to the support surface and displaying such in the GUI;
generating a digital support structure for the user generated 3D model based on the orientation of the user generated 3D model; and
generating a quote for a three dimensional (3D) printed object based on the user generated 3D model.

2. The method of claim 1 wherein:
the user can manually reorient the user generated 3D model within the buildable area about the user generated 3D model's X, Y, or Z axis.

3. The method of claim 1 wherein:
the quote generation system provides the user options for optimizing the orientation of the user generated 3D model to minimize support structure or price; and
calculating the optimal orientation for the user's selected choice and displaying said orientation to the user in the GUI.

4. The method of claim 1 wherein:
the user can selectively hide the support structure in the GUI.

5. The method of claim 1 wherein:
a manufacturer can customize a set of variables affecting the quote.

6. The method of claim 1 further comprising:
scaling the user generated 3D model within the quote generation system.

7. The method of claim 1 further comprising:
detecting defects in the user generated 3D model that would prevent proper manufacture of the three dimensional (3D) printed object;
notifying the user of said defects; and
interrupting generation of the quote when said defects would prevent manufacture of the three dimensional (3D) printed object.

8. The method of claim 7 wherein:
the user is prompted to contact an administrator when generation of the quote is interrupted.

9. The method of claim 7 wherein:
defects detected in the user generated 3D model are selected from the group comprising:
thin walls;
non-manufacturable holes; and
non-manufactuable dimensions.

10. The method of claim 1 further comprising:
manufacturing the three dimensional (3D) printed object.

11. A method of manufacturing a three-dimensional (3D) object, the method comprising:
providing a digital manufacturing system, the manufacturing system providing a graphical user interface (GUI) to a customer;
receiving digital information from the customer wherein the digital information comprises: a digital representation of the 3D object;
displaying the digital representation in the GUI;
generating a digital support structure for the digital representation corresponding to a support structure for the 3D object;
calculating a quotation for 3D printing the 3D object based upon a set of cost-affecting parameters determined by computer assessment of at least the 3D object and support structure;
communicating the quotation to the customer; and
upon acceptance of the computer calculated quotation by the customer, 3D printing the three dimensional object.

12. The method of claim 11 further comprising:
generating a 3D envelope around the digital representation, the 3D envelope corresponding to the X, Y, and Z dimensions of the user generated 3D model;
instantiating a buildable area and a support surface in the quote generation system; and
displaying the buildable area, support surface, and 3D envelope in the GUI.

13. The method of claim 12 wherein:
the 3D envelope is automatically oriented in the buildable area such that it connects to the support surface; and
the digital support structure connects portions of the 3D object to the support surface.

14. The method of claim 13 wherein:
the customer can reorient the digital representation in the buildable area around the X, Y, or Z axis of the digital representation; and
the digital manufacturing system automatically recalculating the amount of support structure required for a new orientation and displaying said new support structure in the GUI.

15. The method of claim 14 wherein:
the user can selectively hide the support structure in the GUI.

16. A method for generating a price quote for at least one three dimensional (3D) printed object comprising:
receiving a customer's computer aided drafting (CAD) file corresponding to at least one 3D printable object;
providing the customer with at least one computer menu of customer-selectable options for manufacturing the at least one 3D printable object, and allowing the customer to select one of the provided customer-selectable options;
assessing the customer's CAD file via computer to determine the volume of material in the at least one 3D printable object, the amount of support structure required to print the at least one 3D printable object; and the time required to print the at least one 3D printable object;
computer calculating a price quote for 3D printing the at least one 3D printable object based on at least the material in the at least one 3D printable object, the amount of support structure required to print the at least one 3D printable object; and the time required to print the at least one 3D printable object, thereby generating a price quote; and
communicating the quote to the customer via computer.

17. The method of claim 16 wherein:
computer calculating the price quote further comprises accounting for variables selected from the list comprising:
the number of changes in printing heads;
the amount of material wasted; and
time thresholds.

18. The method of claim 16 further comprising:
generating a buildable area comprising an open area and a build tray;
orienting the CAD file within the buildable area such that it is located on the build tray; and
generating the support structure required to print the at least one 3D printable object corresponding the CAD file as oriented in the buildable area.

19. The method of claim 18 wherein:
the user can manually re-orient the CAD file along the X, Y, or Z axis of the CAD file; and wherein
the computer recalculates the price quote based on the orientation of the CAD file.

20. The method of claim 19 wherein:
the amount of support structure estimated has less than a ten percent error when compared to the amount of support structure actually required to print the at least one 3D printable object.
